(19) United States
(12) Patent Application Publication
(10) Pub. No.: US 2005/0169604 A1
(43) Pub. Date: Aug. 4, 2005

(54) Storage medium in which audio-visual data with event information is recorded, and reproducing apparatus and reproducing method thereof

(75) Inventors: Kwang-min Kim, Anyang-si (KR); Jung-ho Lee, Yongin-si (KR); Hyun-kwon Chung, Seoul (KR); Kil-soo Jung, Hwaseong-si (KR); Man-seok Kang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/045,065

(22) Filed: Jan. 31, 2005

(30) Foreign Application Priority Data
Feb. 2, 2004 (KR) 2004-6652

(51) Int. Cl. H04N 5/76; H04N 5/781

(52) U.S. Cl. 386/69; 386/95; 386/125

(57) ABSTRACT

A storage medium in which audio-visual data with event information is recorded, and a reproducing apparatus and reproducing method thereof, includes: audio-visual (AV) data; and event information to activate an event when a predetermined specific scene is reproduced while reproducing the AV data and to execute a predetermined program application corresponding to the activated event by synchronizing the program application with the specific scene. Accordingly, the storage medium may be controlled so that an application having a program function is synchronized with a specific scene of the AV data using the event information while reproducing the entirety of the AV data or a portion of the AV data.

### CROSS-REFERENCE TO RELATED APPLICATION

This application claims the benefit of Korean Application No. 10-2004-0006652, filed Feb. 2, 2004, in the Korean Intellectual Property Office, the disclosure of which is incorporated herein by reference.

### BACKGROUND OF THE INVENTION

1. Field of the Invention

The present invention relates to the reproduction of multimedia data, and, more particularly, to a storage medium in which audio-visual data with event information is recorded, and a reproducing apparatus and a reproducing method thereof.

2. Description of the Related Art

In a conventional multimedia storage medium, encoded audio-visual (AV) data, navigation data to control reproduction of the AV data, and a movie object are recorded. In more detail, the AV data includes AV stream data including video data and audio data encoded on the basis of an MPEG standard, and/or additional information, such as a sub picture to display subtitles, and information data including encoding attribute information of the AV stream data or time-to-position information of the AV stream data. The navigation data includes additional information, such as an AV data reproducing order, AV data reproducing time, and entry points for random access designated by a contents manufacturer. The movie object includes navigation commands to control the reproduction of the AV data, such as commands to reproduce the AV data using the navigation data and commands to jump to other navigation data. Accordingly, the AV data may be reproduced using the navigation commands in the storage medium, and a user may watch a movie. Hereinafter, a set of the navigation commands will be called the movie object.

However, in a conventional storage medium in which AV data is recorded, a program such as a game or chatting using reproduced AV data to provide a user interactive operation or an application, such as an application providing a browsing operation to retrieve information related to the reproduced AV data from a markup document and display the information, to which a program operation is added cannot be recorded together with the AV data in one storage medium. That is, with a conventional storage medium in which AV data is recorded, the AV data may be simply reproduced, but additional applications, such as a program to provide a user interactive operation, cannot be provided.

### SUMMARY OF THE INVENTION

Aspects of the present invention provide a storage medium in which audio-visual data with event information is recorded, and a reproducing apparatus and reproducing method thereof.

According to an aspect of the present invention, there is provided a storage medium comprising: audio-visual (AV) data; and event information to activate an event when a predetermined specific scene is reproduced while reproducing the AV data and to execute a predetermined program application corresponding to the activated event by synchronizing the program application with the specific scene.

According to an aspect of the invention, the event information may comprise: event data indicating that the specific scene is being reproduced; and an event descriptor in which the program application corresponding to the event data is defined. The event data may be included in the AV data. The event data may be included in AV stream data or information data constructing the AV data. The event data may include information indicating that predetermined data included in the AV data is the event data, information indicating a point in time when the event is to be activated, an event identifier, and/or additional information.

According to an aspect of the invention, the event data may be included in the AV stream data, the information indicating a point in time when the event is to be activated may be a position of a bitstream including the event data within the AV stream data. The event descriptor may include an event identifier, information regarding a program application to be executed, and/or additional information required to execute the program application. The event descriptor may be recorded separately from the event data included in the AV data. The event descriptor may be included in an application management table in which information regarding an operation of the program application is recorded. The program application may further include a program operation to provide an additional operation to a user and is realized by a program language selected from the group consisting of JAVA and a markup language. According to another aspect of the present invention, there is provided a reproducing apparatus comprising: a presentation engine activating an event when a specific scene indicated by event information is reproduced while reproducing audio-visual (AV) data including the event information and transmitting information regarding the activated event to an application manager, wherein the application manager controls a program application indicated by the event information and corresponding to the activated event to be synchronized with the specific scene and executed. The presentation engine may activate the event when the specific scene is reproduced based on event data constituting the event information and indicating that the specific scene is being reproduced, and the application manager may control the program application to be executed with reference to an event descriptor in which the program application corresponding to the activated event is defined. The event data may be included in AV stream data or information data constituting the AV data, and the presentation engine may reproduce the AV data including the event data. The event data may include information indicating that predetermined data included in the AV data is the event data, information indicating a point in time when the event is to be activated, an event identifier, and/or additional information, and the presentation engine may activate the event corresponding to the event identifier while reproducing the AV data on the basis of the information indicating the point in time when the event is to be activated and transmit the activated event to the application manager along with the event identifier.

According to an aspect of the invention, when the event data is included in the AV stream data, the presentation engine may use a position of a bitstream including the event data within the AV stream data as the information indicating the point in time when the event is to be activated.

According to an aspect of the invention, the event descriptor may include the event identifier, information regarding the application to be executed, and/or additional information required to execute the application, and the application manager may receive the identifier of the activated event from the presentation engine, obtain information regarding the program application to be executed corresponding to the event identifier with reference to the event descriptor, and control execution of the program application.

According to an aspect of the invention, the event descriptor may be represented in a table format separately from the event data included in the AV data or be included in an application management table in which information regarding the program application is recorded, and the application manager may control the execution of the program application with reference to the table or the application management table.

According to another aspect of the present invention, there is provided a reproducing method comprising: reproducing audio-visual (AV) data including event information; and if a specific scene indicated by the event information is reproduced while reproducing the AV data, activating an event, synchronizing a predetermined program application corresponding to the activated event with the specific scene, and executing the program application.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates data stored in a storage medium according to an embodiment of the present invention;

FIG. 2 is a block diagram of an apparatus for reproducing AV data in which event information is included according to an embodiment of the present invention;

FIG. 3 illustrates event data included in an AV stream according to an embodiment of the present invention;

FIG. 4 is a table illustrating event data included in an information file according to another embodiment of the present invention; and

FIG. 5 is a table illustrating an event descriptor according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

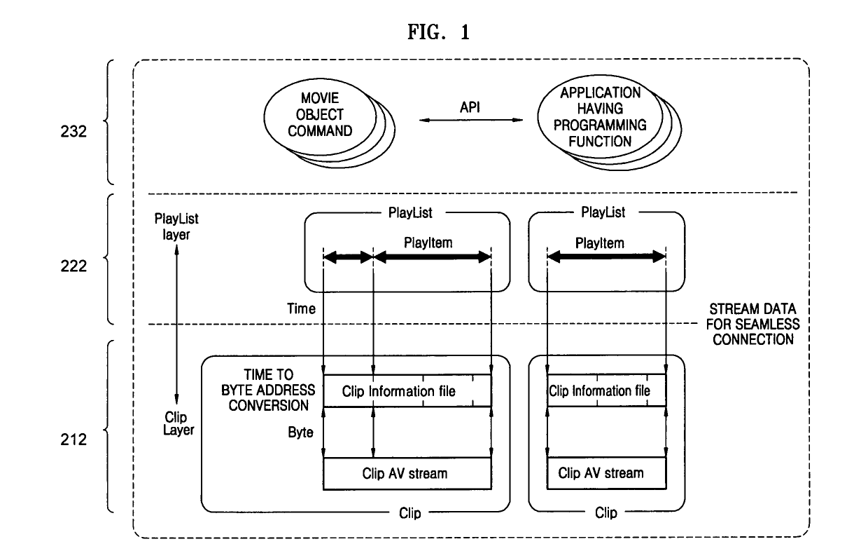

FIG. 1 illustrates data stored in a storage medium according to an embodiment of the present invention. Referring to FIG. 1, the storage medium stores AV data 212, navigation data 222, and application data 232. The AV data 212 includes a plurality of clips, which are storing units of the AV data. Each clip includes AV stream data and information data.

The AV stream data may be realized by a clip AV stream file in which video, audio, and/or additional information such as a sub picture to display subtitles are encoded according to an MPEG standard and recorded. However, it is understood that other standards may be used.

The information data may be realized by a clip information file in which encoding attribute information of the AV stream data or time-to-position information of the AV stream data (data to convert time to byte addresses) is included.

The navigation data 222 includes a plurality of playlists, which are reproducing units of the AV data 212. Each playlist includes a plurality of playitems, each including information related to a reproduction of a corresponding clip to be reproduced. The application data 212 includes movie objects to simply reproduce the AV data 222 and program applications which perform program operations.

When basic AV data 212 is reproduced, a reproducing order and time is obtained by reading playlists using a navigation command. Also, the reproducing time is converted to byte addresses by reading a clip information file corresponding to the reproducing time based on the reproducing order. The AV data 212 is then reproduced by reading clip AV stream files corresponding to the converted byte addresses. A mode in which AV data 212 is simply reproduced based on time as described above is called a core mode.

On the other hand, a mode in which program applications performing program operations are reproduced is called a full mode. In the full mode, each program application provides an additional operation to a user while reproducing the entirety of the AV data 212 or a portion of the AV data 212 using an application program interface (API) with a movie object. That is, by synchronizing with a specific scene of a movie, specific information may be provided, or a predetermined program application may operate.

For example, at the beginning of a scene in which a cellphone appears while reproducing the movie, “The Matrix,” an ad application for a company that made the cellphone may automatically be performed. Also, when a panorama of mountains covered with snow is shown while reproducing the movie, “The Lord of The Rings,” an application providing a description, travel information, and special features of a province where the background of the scene is located may be provided.

In order to synchronize a program application with a specific scene included in the AV data, which is being reproduced, event information (or mark information) informing the application that the specific scene of the AV data 212 is being reproduced is required. A detailed configuration of the event information will be described below.

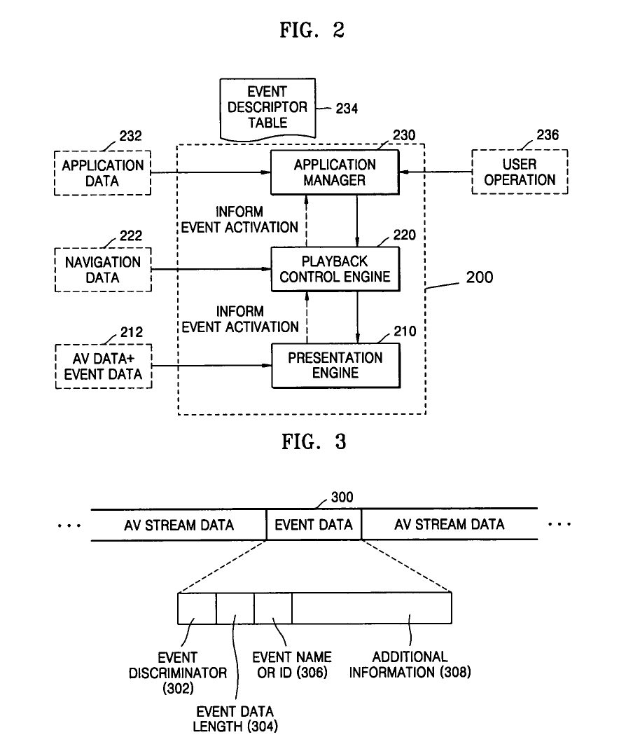

FIG. 2 is a block diagram of an apparatus 200 to reproduce AV data 212 in which event information is included according to an embodiment of the present invention. Referring to FIG. 2, the reproducing apparatus 200 includes a presentation engine 210, a playback control engine 220, and an application manager 230. While not shown, it is understood that a recording and/or reproducing apparatus 200 transfers the application 232, navigation 222, and AV data 212 with respect to the medium shown in FIG. 1.

The presentation engine 210 reads, decodes, and reproduces AV data 212 and event data 212. The AV data 212 is described above, and the reproduction of the event data will be described below.

The playback control engine 220 reads navigation data 222, as described above, and controls the presentation engine 210 to reproduce the AV data 212 based on the navigation data 222.

The application manager 230 manages and controls the execution and termination of each application, which is provided with a program language, such as Java, or a markup language. The application manager 230 reads application data 232, such as the movie objects and program applications described above, and commands the playback control engine 220 to reproduce the corresponding AV data 212. Also, the application manager 230 receives a user operation 236 and controls the playback control engine 220 to reproduce the AV data 212.

In more detail, a process of reproducing AV data 212 in the core mode will now be described. The application manager 230 executes a navigation command such as PlayPL (playlist1) included in a movie object, which is included in the application data 232. The playback control engine 220 reads a corresponding playlist file in the navigation data 222 indicated by the navigation command and obtains the name of a clip file to be reproduced and information related to the reproduction from a playitem included in the playlist file. The presentation engine 210 reads a corresponding clip information file using the clip file name, obtains attribute information of a clip AV stream file included in the AV data 212, and reproduces the clip AV stream file using the obtained attribute information.

Mark information to detect a specific position of the AV data 212 using the user operation 236 or a command is included in the navigation data 222. The playback control engine 220 may receive the user operation 236 or a command prepared by a manufacturer, included in the application data 232, change a reproduction position based on the mark information, and reproduce the AV data 212. The mark information includes a chapter mark indicating a point of time to discriminate chapters of a movie and a skip mark used for a quick search.

A process of reproducing AV data 212 and applications to which program operations are added in the full mode in which a user interactive operation is added will now be described. In the full mode, the applications made using a program language, such as Java, or a markup language, in order to provide the user interactive operation, are provided along with the AV data 212. The applications may provide an ability to reproduce the AV data 212 under a specific purpose using an entire movie or a portion of the movie based on a manufacturer's intention and playing a game based on the AV data 212 to a user. For example, while the movie is being reproduced on a portion of a screen, information related to the movie, such as still images or documents, may be provided on the remaining portion of the screen along with the movie. For a game application, a movie may run as a background to a game, a scene of the movie may be inserted into the middle of the game, or a movie having the same characters but a different story based on results of the game may be provided.

In an aspect of the present invention, the event information is added to the AV 212 data to provide specific information in synchronization with a specific scene of a movie or to operate a predetermined specific application. The event information includes event data and an event descriptor. The event data is included in the AV data 212 and indicates that a specific scene, a specific character, or a specific item appears in scenes of the movie which is being reproduced. The event descriptor provides application-related information, such as designation of a program application or operation to be performed, when an event is activated by the event data.

In more detail, the event data is included in the AV data 212 and includes information indicating an event, an identifier (ID) of the event, and information indicating an event activation time, and/or additional information.

The information indicating an event (hereinafter referred to as “an event discriminator”) is used to discriminate the event data from the AV data and indicates that data with a predetermined length following the event discriminator is the event data. The event ID is used to identify a specific event out of a plurality of events. The event ID should generally have a unique value, but could be a general ID for in plural scenes/playlists.

The information indicating an event activation time is information indicating the reproduction time when a specific scene, during the reproduction of which a specific application is to be performed, is reproduced. When the event data is included in a clip information file, the time information should be explicitely stated. However, when the event data is included in an AV stream, the event data is added to a bitstream of the AV stream data corresponding to a specific scene to operate a specific application, and the time information does not have to be explicit. That is, a position of the bitstream including the event data is the time information.

The additional information may be included by the manufacturer and provides the user with information not concerning the operation of applications. For example, a description of a specific event may be included in the additional information. However, it is understood that users and/or distributors could to the additional information.

Two examples of the event data will now be described. FIG. 3 illustrates event data 300 included in an AV stream according to an embodiment of the present invention. Referring to FIG. 3, the event data 300 additionally added to AV stream data is shown.

As illustrated in FIG. 1, the AV data 212 includes AV stream data (clip AV stream files) and information data (clip information files). The format of the event data 300 differs according to whether the event data 300 is included in the AV stream data or the information data. The shown embodiment corresponds to the former case in which the data 300 is the AV stream. Since the AV stream data into which video, audio, and other additional data are multiplexed is constructed as a single bitstream, the event data 300 also may be represented as a bitstream beginning at a specific bit of the bitstream containing the AV stream data based on a predetermined format. The event data 300 has an event discriminator 302 to discriminate itself from the AV stream data and includes event data length information 304, an event ID 306, and/or additional information 308. As described above, since a position of the bitstream including the event data 300 is information regarding an activation time of the event data 300, the information regarding the activation time of the event data 300 does not have to be included in the present embodiment.

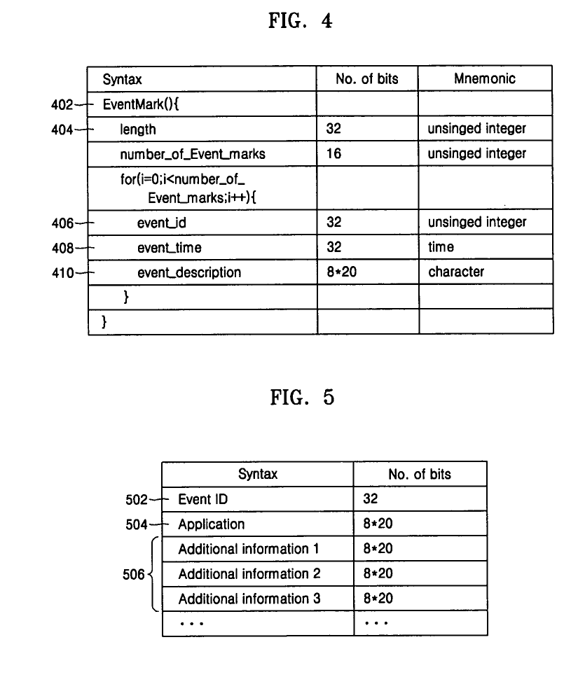

FIG. 4 is a table illustrating event data included in an information file according to another embodiment of the present invention. Referring to FIG. 4, the event data additionally added to information data (a clip information file) is shown. The information data includes attribute information of video, audio, and additional data which are included in AV stream data, and time-to-position information of bitstreams with a predetermined table format. Therefore, the information data may define information required for the event data and include the information in the table format. Referring to FIG. 4, “EventMark( )” denotes an event discriminator 402, “length” denotes event data length information 404, “event_id” denotes an event ID 406, “event_time” denotes event data activation time information 408, and “event_description” denotes additional information 410. The event data shown in FIG. 4 is exemplary, and may be changed if necessary.

Hitherto, event data indicating that a specific scene is being reproduced during the reproduction of AV data has been described. An event descriptor designating a specific application or operation to be executed when an event is activated will now be described with reference to the embodiment shown in FIG. 5.

FIG. 5 is a table illustrating the event descriptor according to an embodiment of the present invention. Referring to FIG. 5, the event descriptor includes an event ID 502, information 504 on a specific program application to be executed, and/or additional information 506 such as a description of the specific program application. The event descriptor may be realized in a table including the various kinds of information. In more detail, the event ID 502 is used to identify the type of an activated event. The application information 504 includes the name of the application that is to operate when event data included in AV data 212 is activated. If specific event data is activated, an event descriptor including an event ID identical to the event ID included in the specific event data is selected, and a specific application corresponding to application information included in the selected event descriptor is executed.

The additional information 506 may include start-up parameters of the application, position information of the application, information required to operate the application, and/or description information of the application.

A method of reproducing a storage medium in which AV data including the event information according to the present invention is recorded using the reproducing apparatus shown in FIG. 2 will now be described. Referring to FIG. 2, the presentation engine 210 reproduces the AV data 212 in which the event data is included under the control of the playback control engine 220. When a reproducing time designated by an event activation time information is reached, the presentation engine 210 informs the playback control engine 220 of the event activation on the basis of the event data by using an event ID. The playback control engine 220 informs the application manager 230 of the event activation by using the event ID.

The application manager 230 searches for program application information corresponding to the ID of the activated event with reference to an event descriptor table 234 stored in the storage medium or memory. The application manager 230 executes a corresponding program application using the name of the application, position information of the application, and information required to execute the application based on the searched program application information. The position information of the application may be included in the event descriptor table 234 or an application management table (AMT) in which information regarding applications is managed. Also, the event descriptor table 234 may be included in the AMT.

In brief, the reproducing method includes: reproducing AV data including event data; and, if an event is activated on the basis of the event data while reproducing the AV data, executing a specific application corresponding to the activated event with reference to a corresponding event descriptor.

While not required, the embodiments of the present invention may be written as computer programs and may be implemented in general-use digital computers that execute the programs using a computer readable recording medium. Examples of the computer readable recording medium include magnetic storage media (e.g., ROM, floppy disks, hard disks, flash media, etc.), optical recording media (e.g., CDs, DVDs, Blu-ray, Advanced Optical Disks, etc.), and storage media such as carrier waves (e.g., transmission through the internet). The computer readable recording medium may also be distributed over network coupled computer systems so that the computer readable code is stored and executed in a distributed fashion.

While shown as being included on a common medium, it is understood that each of the applications need not be on the same medium as the AV data and can be accessed from another medium via a network accessible by the apparatus.

As is described above, according to embodiments of the present invention, a storage medium in which AV data with event information is recorded, and a reproducing apparatus and reproducing method thereof are provided.

The storage medium can be controlled so that an application to which a program operation is added is synchronized with a specific reproducing time of the AV data using the event information while reproducing the entirety of the AV data or a portion of the AV data.

Although a few embodiments of the present invention have been shown and described, it would be appreciated by those skilled in the art that changes may be made in these embodiments without departing from the principles and spirit of the invention, the scope of which is defined in the claims and their equivalents.

1. A storage medium for use with a recording and/or reproducing apparatus, the storage medium comprising:
audio-visual (AV) data; and
event information to cause the apparatus to activate an event when a predetermined specific scene is reproduced by the apparatus while reproducing the AV data and to execute a predetermined program application corresponding to the activated event by synchronizing the program application with the specific scene.

2. The storage medium of claim 1, wherein the event information comprises:
event data indicating that the specific scene is being reproduced; and
an event descriptor in which the program application corresponding to the event data is defined.

3. The storage medium of claim 2, wherein the event data is included in the AV data.

4. The storage medium of claim 3, wherein the AV data comprises the AV stream data and information data related to the AV stream data and the event data is included in the AV stream data or the information data.

5. The storage medium of claim 4, wherein the event data includes information indicating that predetermined data included in the AV data is the event data, information indicating a point in time when the event is to be activated, an event identifier, additional information, or combinations thereof.

6. The storage medium of claim 5, wherein the event data is included in the AV stream data, and the information indicating a point in time when the event is to be activated is a position of a bitstream including the event data within the AV stream data.

7. The storage medium of claim 2, wherein the event descriptor includes an event identifier, information regarding a program application to be executed, and/or additional information required to execute the program application.

8. The storage medium of claim 7, wherein the event descriptor is recorded separately from the event data included in the AV data.

9. The storage medium of claim 7, wherein the event descriptor is included in an application management table in which information regarding an operation of the program application is recorded.

10. The storage medium of claim 1, wherein the program application further includes a program operation to provide an additional operation to a user and is realized by a program language selected from the group consisting of JAVA and a markup language.

11. A reproducing apparatus comprising:
an application manager; and
a presentation engine activating an event when a specific scene indicated by event information is reproduced while reproducing audio-visual (AV) data including the event information and transmitting information regarding the activated event to an application manager, wherein the application manager controls a program application indicated by the event information and corresponding to the activated event to be synchronized with the specific scene and executed.

12. The apparatus of claim 11, wherein the presentation engine activates the event when the specific scene is reproduced based on event data constituting the event information and indicating that the specific scene is being reproduced.

13. The apparatus of claim 12, wherein the application manager controls the program application to be executed with reference to an event descriptor in which the program application corresponding to the activated event is defined.

14. The apparatus of claim 13, wherein the event data is included in AV stream data or information data constituting the AV data, and
the presentation engine reproduces the AV data including the event data.

15. The apparatus of claim 13, wherein the event data includes information indicating that predetermined data included in the AV data is the event data, information indicating a point in time when the event is to be activated, an event identifier, and/or additional information, and
the presentation engine activates the event corresponding to the event identifier while reproducing the AV data on the basis of the information indicating the point in time when the event is to be activated and transmits the activated event to the application manager along with the event identifier.

16. The apparatus of claim 15, wherein when the event data is included in the AV stream data, the presentation engine uses a position of a bitstream including the event data within the AV stream data as the information indicating the point in time when the event is to be activated.

17. The apparatus of claim 13, wherein the event descriptor includes the event identifier, information regarding the program application to be executed, and/or additional information required to execute the program application, and the application manager receives the identifier of the activated event from the presentation engine, obtains information regarding the program application to be executed corresponding to the event identifier with reference to the event descriptor, and controls execution of the program application.

18. The apparatus of claim 17, wherein the event descriptor is represented in a table format separately from the event data included in the AV data or is included in an application management table in which information regarding the program application is recorded, and
the application manager controls the execution of the program application with reference to the table or the application management table.

19. A reproducing method comprising:
reproducing audio-visual (AV) data including event information; and
when a specific scene indicated by the event information is reproduced while reproducing the AV data, activating an event, synchronizing a predetermined program application corresponding to the activated event with the specific scene, and executing the program application.

20. A storage medium for use with a recording and/or reproducing apparatus, the storage medium, comprising:
audio/visual (AV) data, including a plurality of clips including AV stream data and information data;
navigation data, including a plurality of playlists to define to the apparatus reproducing units of each of the clips of the AV data; and
application data, including movie objects used by the apparatus to reproduce the AV data and program applications used by the apparatus to perform program operations.

21. The storage medium according to claim 20, wherein the AV stream data is realized by a file in which video, audio, and/or additional information are encoded according to an MPEG standard.

22. The storage medium according to claim 21, wherein the additional information comprises a sub picture to display subtitles.

23. The storage medium according to claim 20, wherein the information data is realized by a file in which encoding attribute information or time-to-position information is included.

24. The storage medium according to claim 20, wherein each playlist includes a plurality of playitems, each of the playitems including information related to reproduction of a corresponding clip.

25. The storage medium according to claim 24, wherein when AV data is reproduced, a reproducing order and time is obtained by the apparatus reading the playlists using a navigation command, and the time is converted to byte addresses by reading a file corresponding to the reproducing time based on the reproducing order.

26. The storage medium according to claim 25, wherein the AV data is reproduced by reading AV stream files corresponding to the converted byte addresses.

27. The storage medium according to claim 26, wherein a core mode is a mode in which AV data is reproduced based on time and a full mode is a mode in which program applications, performing program operations, are reproduced.

28. The storage medium according to claim 27, wherein each program application instructs the apparatus to provide an additional operation to a user while reproducing an entirety of the AV data or a portion of the AV data using an application program interface (API) with a movie object.

29. The storage medium according to claim 28, wherein the apparatus synchronizes event data with a specific scene of a movie such that specific information is provided and/or a predetermined program application operates.

30. An apparatus to reproduce audio/visual (AV) data in which event information is included, comprising:
a presentation engine reproduce the AV data and the event data;
a playback control engine to read navigation data read from the AV data and to control the presentation engine to reproduce the AV data based on the navigation data; and
an application manager to control the execution and termination of applications by reading application data stored with the AV data and accordingly commanding the playback control engine.

31. The apparatus according to claim 30, wherein the application manager receives a user operation and accordingly controls the playback control engine.

32. A method of reproducing audio/visual (AV) data, comprising:
executing a navigation command, which is included in stored application data;
reading a corresponding file in stored navigation data indicated by the navigation command and obtaining a name of a clip file to be reproduced and information related to the reproduction;
reading a corresponding clip information file using the obtained clip file name;
obtaining attribute information of a clip AV stream file included in the AV data; and
reproducing the clip AV stream file using the obtained attribute information.

33. The method according to claim 32, wherein the navigation command is a PlayPL (playlist1) included in a movie object.

34. The method according to claim 33, wherein the information related to the reproduction is stored in a playitem included in the playlist file.

35. The method according to claim 34, wherein mark information to detect a specific position of the AV data is included in the navigation data.

36. The method according to claim 32, further comprising adding a user interactive operation such that event information is added to the AV data to provide specific information in synchronization with a portion of the AV data or to operate a predetermined specific application in a full mode.

37. The method according to claim 36, wherein the event information includes event data to indicate that a specific scene, a specific character, or a specific item appears in scenes of the movie which is being reproduced and an event descriptor to provide application-related information when an event is activated by the event data.

38. The method according to claim 36, wherein the event data comprises:
information indicating an event to discriminate the event data from the AV data an to indicate that data with a predetermined length following the event discriminator;
an identifier (ID) of the event to identify an event out of a plurality of events; and
information indicating an event activation time to indicate a reproduction time of the event.

39. A method of reproducing a storage medium in which audio/visual (AV) data including event information is recorded, the method comprising:
reproducing the AV data, in which the event data is included;
determining that an event is activated based on the event data by using an event ID when a reproducing time designated by event activation time information is reached;
searching for program application information corresponding to the ID of the activated event;
executing a corresponding program application.

40. The method according to claim 39, wherein the executing comprises using the name of the application, position information of the application, and information required to execute the application based on the searched program application information.

41. The method according to claim 39, wherein the position information of the application may be included in the event descriptor table or an application management table (AMT) in which information regarding applications is managed.

42. A reproducing method comprising:
reproducing audio/visual (AV) data including event data; and
if an event is activated on the basis of the event data while reproducing the AV data, executing a specific application corresponding to the activated event with reference to a corresponding event descriptor.

43. A computer readable medium encoded with the method of claim 39 implemented by a computer.

44. A computer readable medium encoded with the method of claim 42 implemented by a computer.
